(19) United States
(12) Patent Application Publication
(10) Pub. No.: US 2013/0212474 A1
(43) Pub. Date: Aug. 15, 2013

(54) COMPUTER-IMPLEMENTED SYSTEM AND METHOD FOR FACILITATING CREATION OF BUSINESS PLANS AND REPORTS

(71) Applicants: Cynthia K. McCAHON, San Francisco, CA (US); Andrew C. Wall, San Francisco, CA (US); Adarsha Raghavendra, Santa Clara, CA (US)

(72) Inventors: Cynthia K. McCAHON, San Francisco, CA (US); Andrew C. Wall, San Francisco, CA (US); Adarsha Raghavendra, Santa Clara, CA (US)

(21) Appl. No.: 13/586,771

(22) Filed: Aug. 15, 2012

Related U.S. Application Data
(63) Continuation-in-part of application No. 13/219,576, filed on Aug. 26, 2011.
(60) Provisional application No. 61/443,674, filed on Feb. 16, 2011.

(51) Int. Cl. G06F 17/24

(52) U.S. Cl. CPC G06F 17/24
USPC 715/256

(57) ABSTRACT

A set of input parameters is received from a user relating to a particular business entity. A report is programmatically generated for the business entity, the report including grammatically correct statements that directly or indirectly reflect the input parameters. The report can be dynamically updated in response to changes made by the user to the set of input parameters.

### CROSS-REFERENCE TO RELATED APPLICATIONS

This application is a continuation-in-part of U.S. patent application Ser. No. 13/219,576, entitled “Computer-Implemented System and Method for Facilitating Creation of Business Plans and Reports,” filed Aug. 26, 2011, which claims priority to U.S. Provisional Application No. 61/443,674 entitled “Computer-Implemented System and Method For Facilitating Creation of Business Plans and Reports”, filed on Feb. 16, 2011. The aforementioned applications are hereby incorporated by reference in its entirety.

### TECHNICAL FIELD

Embodiments described herein pertain generally to a computer-implemented system and method for facilitating creation of business plans and reports.

### BRIEF DESCRIPTION OF THE DRAWINGS

FIG. 1 illustrates a system for generating business plans and reports, according to embodiments.

FIG. 2 through FIG. 12 illustrate various interfaces and functionality for use in implementing one or more embodiments described.

FIG. 3 illustrates an interface in which a user is able to register multiple business entities for a service as described, under an embodiment.

FIG. 4 illustrates an interface in which the user can enter basic business information, according to an embodiment.

FIG. 5 illustrates an interface for prompting a user to enter answers to relevant questions for report generation, according to one or more embodiments.

FIG. 6 illustrates a financial information an interface for prompting the user to provide predictive or actual financial information on products and sales, according to one or more embodiments.

FIG. 7 illustrates an interface for forecasting financial results of the business entity, based in part on financial information provided by the user, according to one or more embodiments.

FIG. 8 illustrates an auto ratio analysis interface that is automatically generated to predict performance of the business based on individual financial ratios.

FIG. 9 illustrates an input interface that is generated to include a graphic feature that displays individual business profile performance parameters within a quartile percentage range, under another embodiment.

FIG. 10 illustrates an interface for a performance metric for use in predicting success of the business entity, according to one or more embodiments.

FIG. 11 illustrates a performance review interface, under another embodiment.

FIG. 12 illustrates an input interface in which the user receives a certificate reflecting the user passing criteria set forth by the web service.

FIG. 13 illustrates a method for programmatically generating a dynamically configurable report, according to an embodiment.

FIG. 14 illustrates an input interface for programmatically generating and altering a report based on a user input, according to an embodiment.

FIG. 15A is a block diagram that illustrates a system for implementing one or more embodiments described.

FIG. 15B illustrates an example interface to enable element selection and inspection, under an embodiment.

FIG. 16 illustrates a hardware system for implementing one or more embodiments described herein.

### DETAILED DESCRIPTION

Embodiments include a system and method for providing automated business reporting and planning information. Among other purposes, embodiments such as described enable users (e.g., business owners, operators, entrepreneurs) to develop goals, objects and strategies for business planning. Additionally, according to some embodiments, a system and method is provided to facilitate users in generating a business plan document that satisfies business industry standards.

In one embodiment, a system is implemented to (i) guide users into providing pertinent information, and (ii) generate planning objects, business planning documentation (e.g., formalized business plan), and predictive success metrics. A system such as described may be implemented to provide output in a manner that is responsive to user input, so as to generate and update output and results (e.g., predictive success metrics, business plans) in real-time. The system may be implemented through, for example, software that executes on a user-machine and/or which is provided on a server as part of an online service.

In an embodiment, a system includes an interface and an analysis module. The interface is configured to prompt and guide users into entering pertinent information about a business entity. The information that can be supplied by users includes, but is not limited to: (i) a particular category of the business, (ii) financial information that includes one or more of (a) revenue forecast, (b) actual revenue, (c) profit/loss forecast, or (d) actual profit/loss. Based on the information provided, a predictive score is generated for the business entity based on one or more predetermined success metrics.

According to one or more embodiments, information provided by the user about a particular business entity may be compared to industry data in order to determine how the business entity is performing (or projected to perform) as compared to other businesses that are similar or are of the same type. The comparison with industry data is used to determine the predictive score for the business entity.

As used herein, the terms “programmatic,” “programmatically” or variations thereof mean through execution of code, programming or other logic. A programmatic action may be performed with software, firmware or hardware, and generally without user-intervention, albeit not necessarily automatically, as the action may be manually triggered.

One or more embodiments described herein may be implemented using programmatic elements, often referred to as modules or components, although other names may be used. Such programmatic elements may include a program, a subroutine, a portion of a program, or a software component or a hardware component capable of performing one or more stated tasks or functions. As used herein, a module or component can exist on a hardware component independently of other modules/components or a module/component can be a shared element or process of other modules/components, programs or machines. A module or component may reside on one machine, such as on a client or on a server, or may alternatively be distributed amongst multiple machines, such as on multiple clients or server machines. Any system described may be implemented in whole or in part on a server, or as part of a network service. Alternatively, a system such as described herein may be implemented on a local computer or terminal, in whole or in part. In either case, implementation of a system provided for in this application may require use of memory, processors and network resources, including data ports, and signal lines (optical, electrical, etc.), unless stated otherwise.

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer programs, or a computer usable carrier medium capable of carrying such a program.

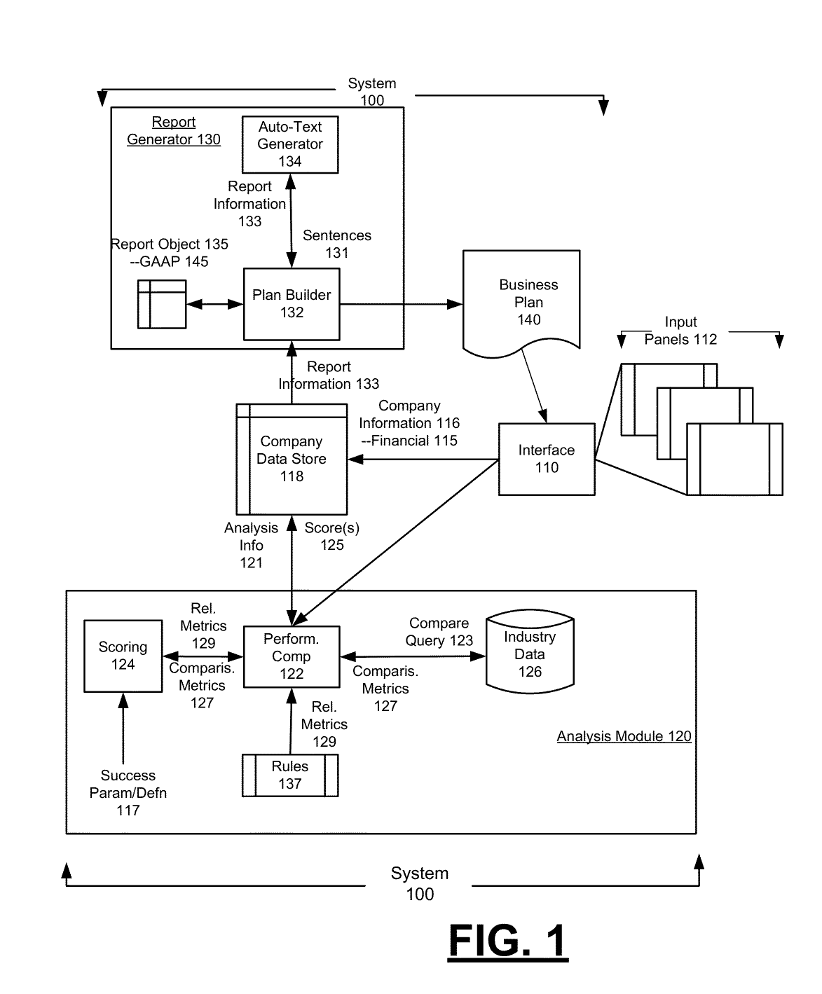

FIG. 1 illustrates a system for generating business plans and reports, according to embodiments. Among other uses, a system such as described can be used to facilitate entrepreneurs and business owners in planning their business. More specifically, system 100 may be used to facilitate business owners in determining their business plan, including determining strategies, goals and objectives. Based on information provided by a user, various business metrics are generated that facilitate the user in understanding strengths and weaknesses of their business planning. Additionally, some embodiments generate one or more predictive success scores to quantify the user's likelihood of success, based on considerations and determinations made by system 100 (including comparisons with other businesses that are deemed to be similar).

Still further, some embodiments provide that system 100 facilitates users in memorializing their business plan. In particular, system 100 may be implemented to programmatically and automatically generate a business plan document from information provided by a user. The business plan document may be automatically generated using information provided by the user. More specifically, the business plan document automatically generates organization, format, and content that is grammatically correct and with structured sentences. The business planning document includes accounting information and content. Among other features, the business plan document may be based on projected or actual financial information provided by the user.

Thus, some embodiments enable the generation of business planning documents to facilitate the business needs of entrepreneurs and business owners. Such business needs may include, for example, loan or investment procurement.

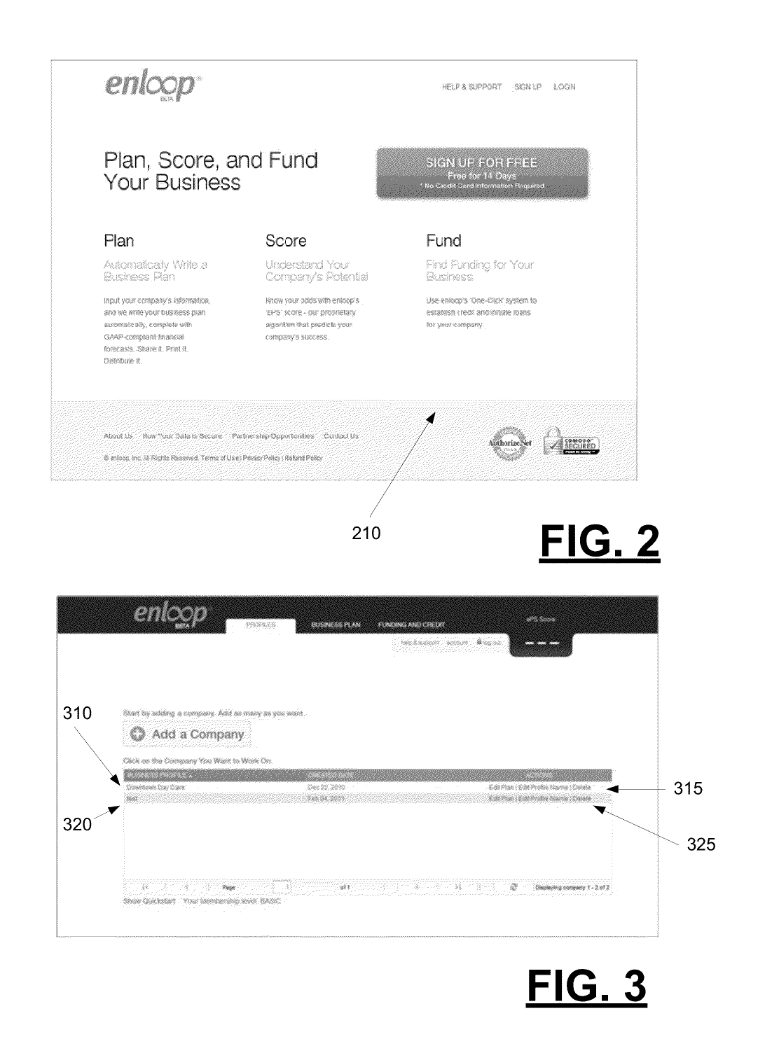

In more detail, system 100 includes an interface module 110, an analysis module 120, and a report generator 130. The interface module 110 generates one or more input panels 112 that prompt and guide a user into providing information about a particular business entity. Among other information, the user may enter a company name, type of business (including sub-categories), geographical location, personnel information (including biographical information about executives and/or other employees, for example), and expected or actual financial information, including profit loss and/or revenue information. Examples of other information that the user may provide are shown in the examples of FIG. 2 through FIG. 11. The panels 112 may guide the user into providing company information and data. For example, the panels 112 may provide the user with choices using graphical features such as pull-down menus, as well as text fields for entering geographical information, and other input fields for entering accounting information. Numerous examples of such panels are provided in the accompanying figures.

In an embodiment, the system 100 is provided as a web service. Accordingly, the interface 110 may generate the input panels 112 as web content that the user interacts with using a browser, or a browser enabled application. The interface module 110 stores company information 116 (including company financial information 115) as a company data store 118. As a web service, the system 100 may store information for numerous business entities provided by numerous businesses and business operators. Thus, processes described with system 100 may be replicated from multiple entities.

The analysis module 120 processes information provided by the user about a particular business entity. In particular, the analysis module 120 performs processes that include (i) comparing the business entity to industry standards, and/or (ii) scoring a business entity based on one or more pre-determined metrics of success. In performing analysis, analysis module 120 utilizes a data store of industry information 126, such as published as Standard Industry Classification (SIC) (also known as ‘NAICS’ (North American Industry Classification)) by the U.S. Census Bureau and other Business Entity sources. Such information lists averages for businesses by category and sub-category. In one embodiment, the analysis module 120 includes a performance component 122 that compares financial and other information provided by the user via the interface module 110 against industry data 126. The performance component 122 may formulate comparison query (or queries) 123, extracted from provided information to compare against industry standards 126. The extracted information may include, for example, financial information 115, as well as information to categorize the business entity by type. The use of comparison information 123 to compare against industry data 126 provides comparison metrics 127 that compare the business entity to the industry standards 126. As mentioned, the information provided by the user maybe anticipated (e.g., the user is in the planning stage), in which case the comparison metrics 127 are only anticipated. Alternatively, the information provided from the user may be actual data, in which case the comparison metrics 127 are actual and/or predictive of future performance.

As an addition or alternative, performance component 122 may extract or otherwise determine other metrics 129 that are deemed relevant to determinations of success. Such metrics 129 may be defined by, for example, rules and considerations 137 that can be defined by experts in particular categories of businesses. The metrics 129 may be based in part on, for example, success or education level of the executive team or business operator, information known about a particular business segment to experts that may not be reflected in industry data (or historically known), geographic specific considerations, accounting for trends in business and various other factors. In this way, the relevant metrics 129 may be defined by rules and/or expert input.

The analysis module 120 includes a scoring component 124 that utilizes the comparison and relevant metrics 127, 129 in order to generate one or more predictive success scores 125 for the business entity. According to one or more embodiments, the success score 125 is predictive of the success of the business entities, based on comparisons to industry standards, as well as other metrics determined or defined from other sources. The following success definitions or parameters 117 may be used in determining facets of success: profitability prediction, prediction that business entity would be acquired, prediction that business entity would stay in business for X number of years, and/or prediction that the business entity would receive financing (loan or equity). According to one or more embodiments, scoring component 124 uses financial information 115 as a basis for determining success scores 125. Such financial information may be compared against industry data 126 to identify how the particular business entity compares to the industry norm for the same category of business.

Additionally, the scoring component 124 includes business type or category specific weights and algorithms for specific industries. For example, sales forecasts, expenses, profit and loss, financial ratios (e.g., liquidity ratios) may comprise variables or parameters that affect the algorithmic determination of the predictive scores 125, particularly as to how the variables compare to industry norms. Other metrics include management parameters, including past success and/or educational background of the executive or management team (or operator) for the entity. The weights assigned to the various variables, as well as identification of those which are actually used in determining predictive success score, may be affected by, for example, the business category type, as well as other considerations such as current economic environment and geographic considerations.

The interface module 110 is also configured to trigger the analysis module 120 in performing its computations. The result is that input from the user results in real-time updates to the output of the analysis module 120. For example, the analysis component 120 may determine information after a required set of information is entered by the user through the panels 112. Additionally, embodiments realize that the user may interact with system 100 in order to plan, adjust and update their business plan (including goals, objectives). When the user makes such adjustments, the analysis module 120 may recalculate its determinations in a manner that is responsive to the user input.

Information determined by the analysis module 120 (“analysis information 121”) can be stored in association with the company information 116 in the company data store 118. The analysis information 121 includes the predictive score(s) 125. The report generator 130 may access the company data store 118 in order to obtain information for report generation and output.

As mentioned, a particular type of report that can be generated from the report generator 130 corresponds to a business plan document 140. More specifically, under some embodiments, the interface module 110 is designed to present the user with features to facilitate input of data that can be converted and otherwise presented in a report. In particular, the interface module 110 may prompt the user to enter information that can be conveyed in a formal business plan document 140. Under one embodiment, plan builder 132 uses company report information 133 from company store 118. The company report information 133 includes select portions of company information 116 (e.g., executive biographical information), accounting or financial information 115, and analysis information 121 (optionally including success scores 125).

The plan builder 132 implements a report object 135 that specifies formatting, organizational structure, and other aspects of a formal business plan. Additionally, report generator 130 may include intelligence, displayed as auto text generator 134, which generates sentences 131 from report information 133. The auto text generator 134 may implement, for example, a series of if/then logic statements, which substitute company information into grammatically correct sentences 131. According to embodiments, the user does not specify the actual sentences that comprise much of the business plan. With the exception of, for example, portions such as executive biographies, much of the content (e.g., text, accounting information, and/or outlines) of the business plan document 140 is generated using programmatically and automatically generated sentences 131. The plan builder 132 structures sentences 131 into the business plan document 140. The business plan document 140 can be output to the user to facilitate the user in, for example, procuring financing, discussing business ideas with peers, or facilitating the user in memorializing his or her goals and objectives.

In generating the business plan document 140, one or more embodiments provide that the plan builder 132 presents accounting information (as provided by the user through input interface 110, and/or through analysis output 121). The report object 135 used to generate the business plan document 140 may include specifications 145 for formatting and content.

FIG. 2 through FIG. 12 illustrate various interfaces and functionality for use in implementing one or more embodiments described with respect to FIG. 1 above. FIG. 2 illustrates an interface 210 for system 100 when implemented as a web service. For example, a user may operate a web browser to navigate to a website, on which system 100 is implemented. The user may enter information about one or more business entities once an account with the service is established. Information provided by the user can be maintained online, and the user has the ability to modify or update information about a particular entity. To access the service, the user may operate a login and password. As an alternative, embodiments described herein may be provided as a stand-alone or client type environment. For example, functionality described with embodiments provided herein may be provided in part, or entirely on a client terminal.

FIG. 3 illustrates that a particular user may have multiple business entities that have profiles through the web service. For example, one user may plan or operate multiple entities 310 and 320. The user may access a particular interface to select one of the business entities that he/she wishes to review, analyze, and/or generate reports.

As shown in FIG. 3, each business entity 310 and 320 may have one or more corresponding options 315 and 325 to assist the user in accessing and/or editing information about each of the entities. For example, a user may be able to edit information corresponding to a particular entity, edit a profile name associated with the business entity and/or delete information about a particular business entity.

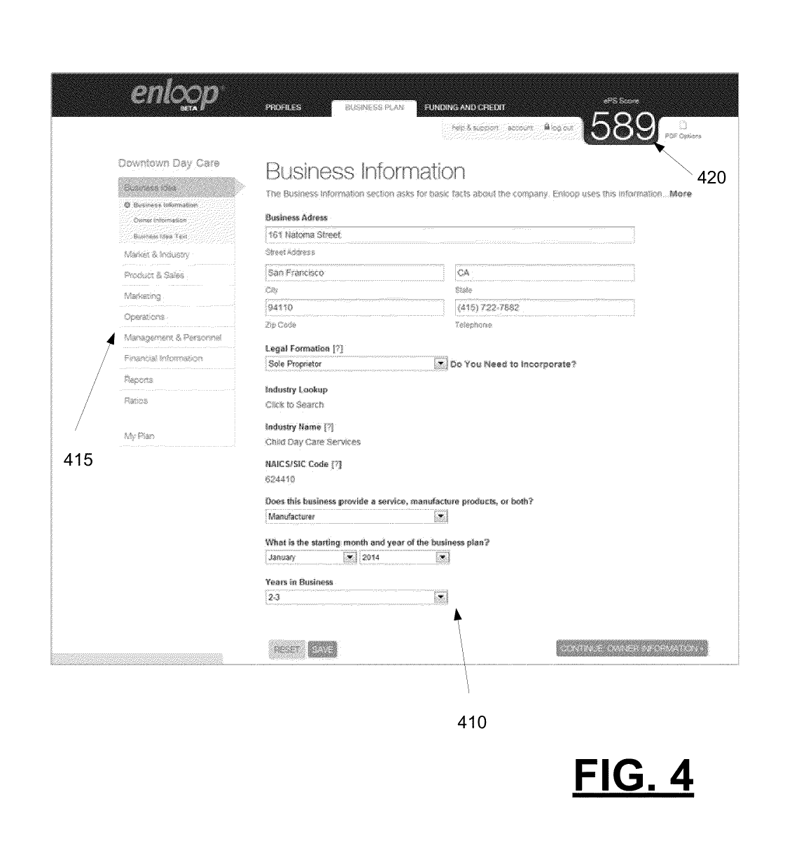

FIG. 4 illustrates a panel 410 in which the user can enter basic business information. According to an implementation shown, when a user selects a business entity, such as, for example business entity 310 (FIG. 3), the user is presented a main business information panel 410 within a framework. The framework enables the user to navigate to different topics where the user can enter and/or edit information and/or see results based on the information. The framework includes subcategories 415 that include additional panels to guide and prompt the user into entering necessary information for generating reports and providing scoring.

As mentioned with an embodiment of FIG. 1, embodiments utilize information provided by the user to generate predictive success scores. Once information is provided by the user through interaction with the service, a predictive success score 420 may be presented on various panels for the user. The user can alter information in one or more of the panels 415 in order to adjust the predictive success score 420. In certain embodiments, the success score 420 can be adjusted and provided to the user in real-time based on the information added or edited by the user. As shown, the predictive success score 420 (e.g., 589) is displayed to the user on the business page, which can serve as a starting point in the sequence of panels that the user can view and interact with.

According to embodiments, the predictive success score 420 is a probabilistic measurement of failure risk/likelihood of success for the business. In the implementation provided, the predictive success score 420 is provided on a scale of 1 to 1000, with a higher number indicating a higher probability of success. Success may be defined in a variety of ways, such as described above (e.g., ability for the business to achieve profitability, ability for the business to be sold for profit, ability for the business to procure financing).

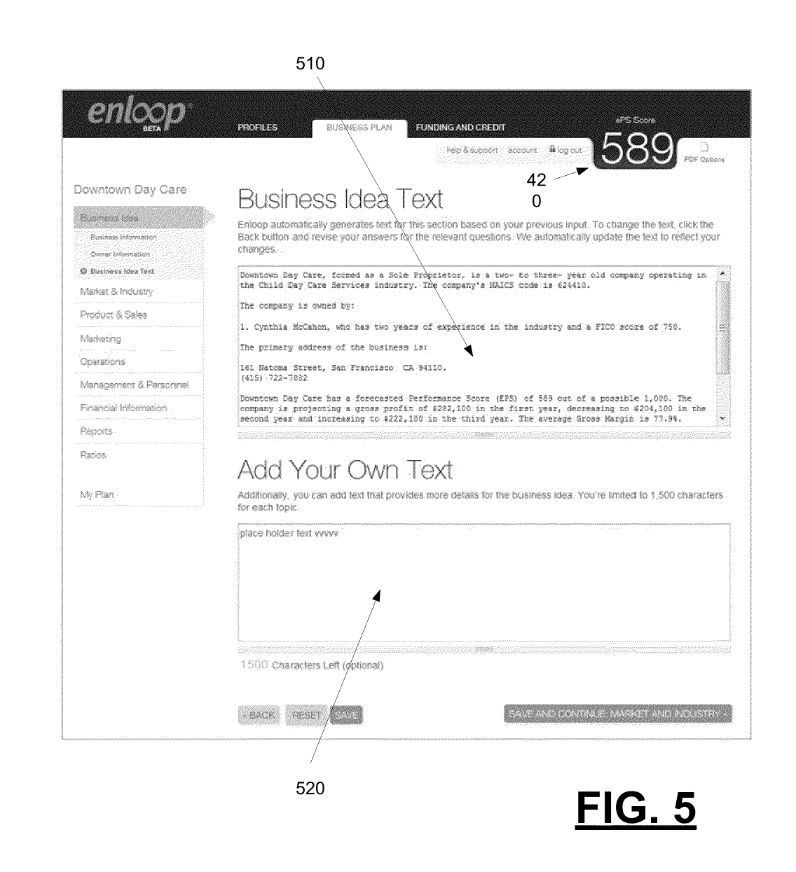

FIG. 5 illustrates an input interface for prompting a user to enter answers to relevant questions for report generation according to one or more embodiments. A text field 510 may include customized text derived from user interaction. Thus, at least some of the text provided in the text field 510 may be programmatically generated. Other text may be manually entered by the user. In one embodiment, the text may be based on previous input. The user can change information entered in, for example, text input field 520 in order to change the text that is programmatically generated and presented to the user in the text field 510.

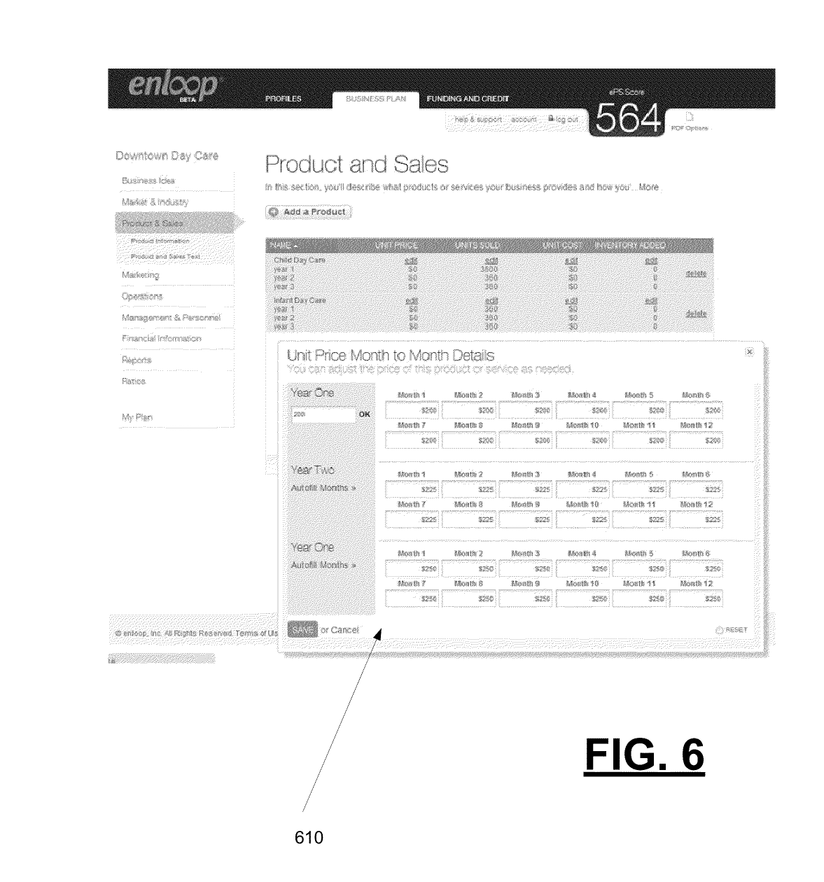

FIG. 6 illustrates a financial information panel for prompting the user to provide predictive or actual financial information on products and sales, according to one or more embodiments. The panel 610 may prompt the user to input some financial information, and may use that information to auto fill other information in the panel 610. For example, the user may enter annual revenue information for a particular year (predictive or actual) and that information is subsequently provided to and displayed in one or more additional years provided on the panel 610. Furthermore, the entered financial information may be maintained for report generation and output.

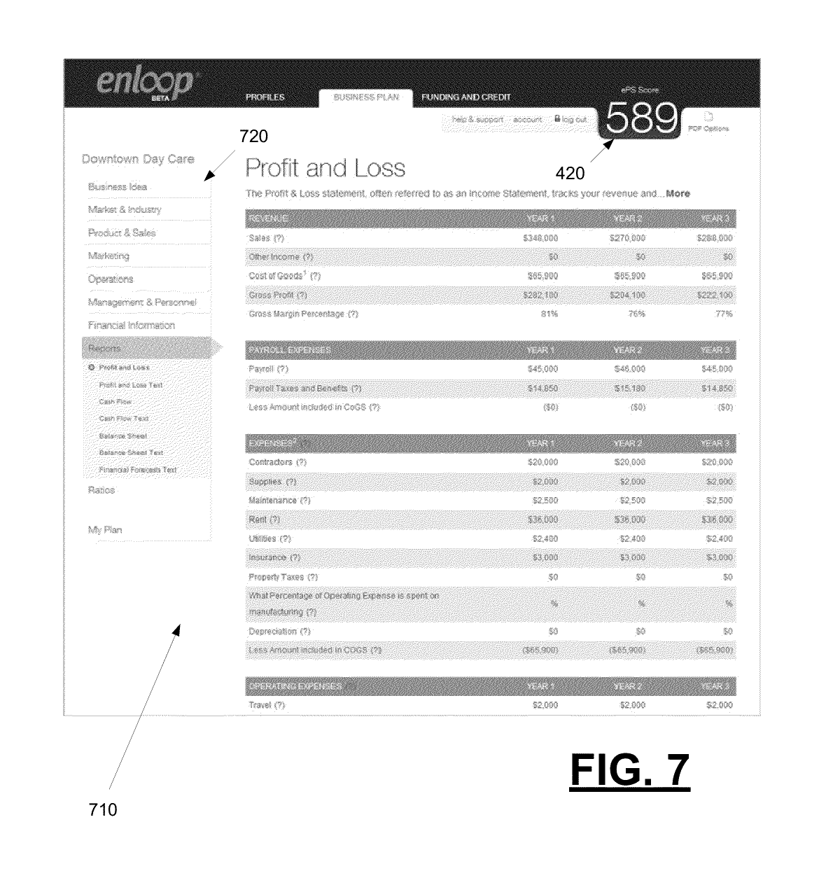

FIG. 7 illustrates a panel 710 for forecasting financial results of the business entity, based in part on financial information provided by the user, according to one or more embodiments. According to an embodiment, an auto forecast technique is implemented to automatically prepare financial forecasts. The financial forecast shown in the panel 710 may be determined in real-time based on user input (i.e., company information 116 (FIG. 1)).

In the example provided, a financial forecast report includes a three-year pro form a forecast with 36-month detailed views of a profit and loss pro form a forecast, a cash flow pro form a forecast, a balance sheet pro form a forecast, and the ratios pro form a forecast. In some embodiments, the forecast information provided in the panel 710 may be updated automatically when the user interacts with data variables provided to other panels. For example, the panels may be arranged in the planning sequence, as identified by the topical heading tabs 720 on the left side of the interface. As the user manipulates certain sections of the input, various outcomes may be affected and updated in real-time, such as financial forecast and/or predictive scoring 420.

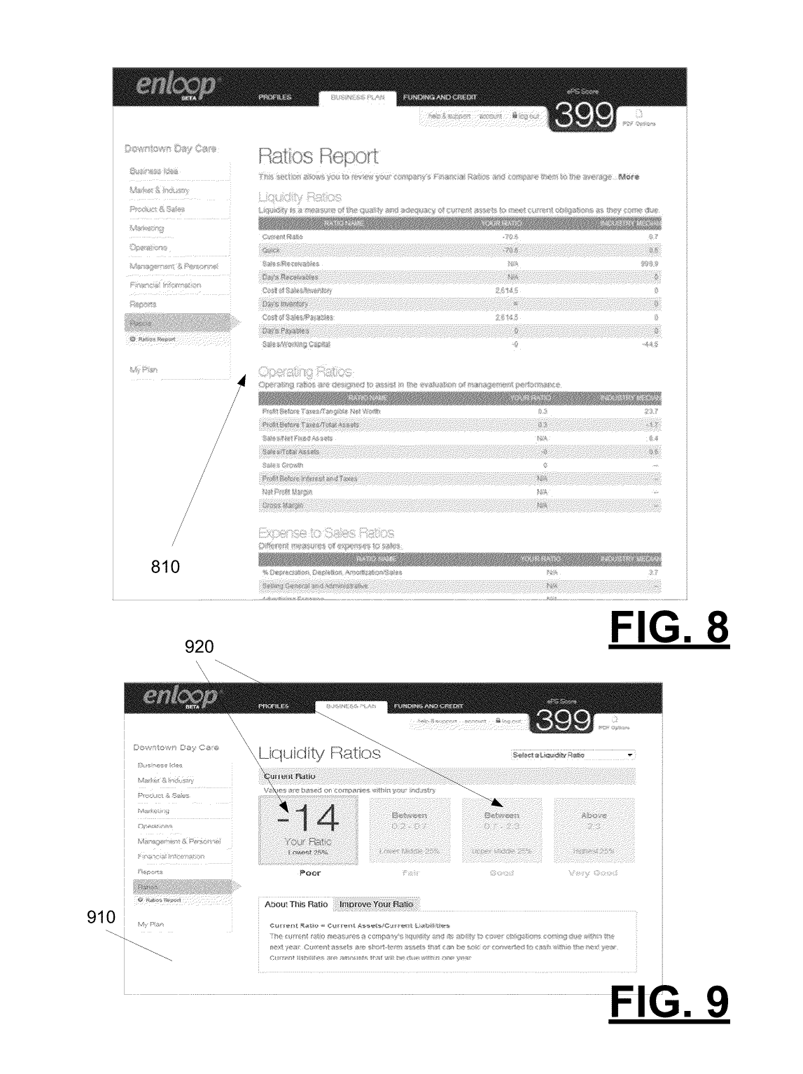

Various predictive performance parameters and metrics may be determined based on information provided from the user. FIG. 8 illustrates an auto ratio analysis panel 810 that is automatically generated to predict performance of the business based on individual financial ratios. The financial ratios may be calculated from the analysis module 120, based on established metrics for an industry.

The analysis module 120 also generates metrics to evaluate the business entity as compared to other businesses that are of same category, or otherwise deemed similar. With reference to FIG. 9, a panel 910 is generated to include a graphic feature 920 that displays individual business profile performance parameters within a quartile percentage range. The performance (or expected performance) of the business under individual accounting ratio is preselected as being relevant to a particular user. Qualitative expressions may accompany the numeric values in the graphic feature 920. In the example shown, the individual ratios are presented and described as “Poor,” “Fair,” “Good” or “Very Good” based on, for example, a comparison to a dataset representative of the business profiles industry average for a particular ratio.

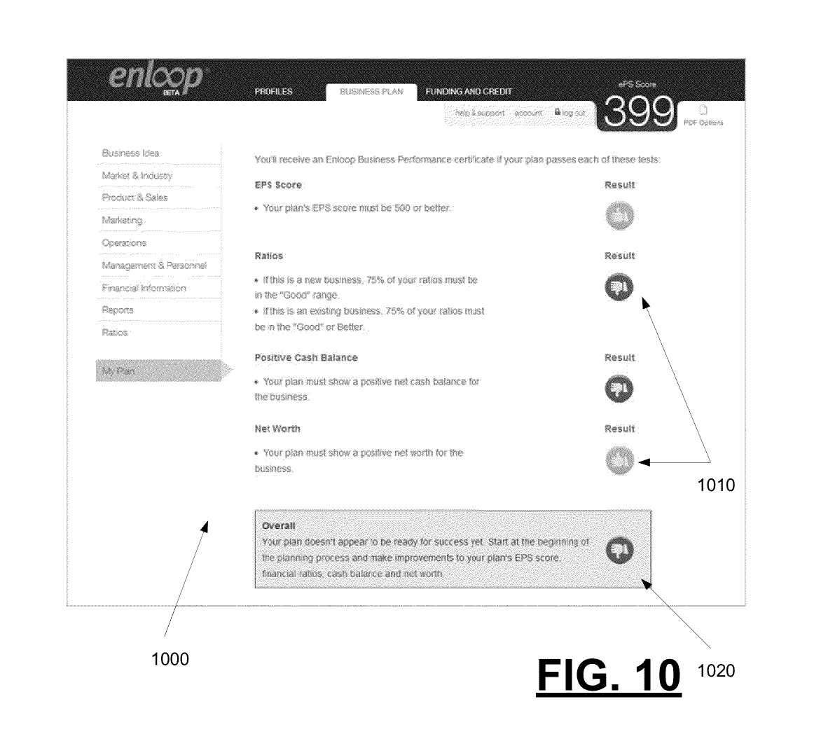

FIG. 10 illustrates another performance metric 1000 for use in predicting success of the business entity, according to one or more embodiments. A performance evaluator parameter provides users estimates of a likelihood of failure or success for business profiles that have undergone a business planning process. Based on the combined analysis of various predictive scores 1010, such as, for example, performance score(s), ratio analysis, cash balance and net worth, the business profile is assigned to either pass or fail result 1020. If the business profile is deemed to fail, the user may be directed back to sections of the business planning sequence that require improvement in order to receive the pass result. Thus, some of the panels provided to the user may display information that prompt the user to revisit his planning strategy based on success or failure predictions.

In certain embodiments, as the user edits and/or alters data in the revisited panels, the pass or fail result 1020 may be updated in real-time accordingly. Thus, if a business entity received a failing result, the user may be able to more accurately determine which areas of the business plan need to be improved to obtain a passing result.

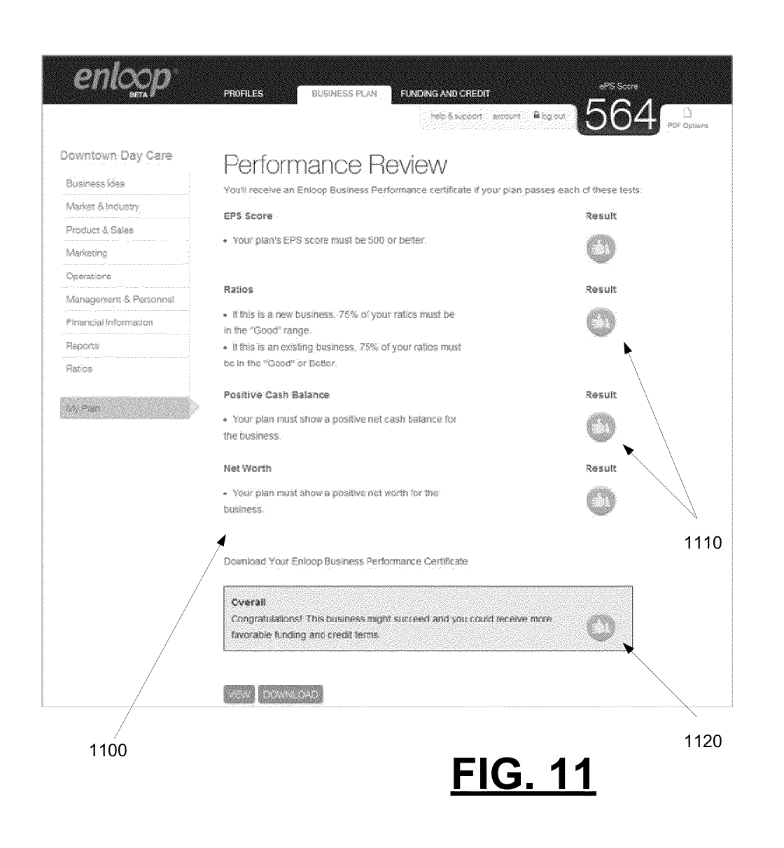

FIG. 11 illustrates a performance review panel 1100 similar to that shown in FIG. 10, except that based on the combined analysis of various predictive scores 1110, such as, for example, performance score(s), ratio analysis, cash balance and net worth, the result shown in the panel has a “Pass” result 1120. According to one or more embodiments, if the requirements for receiving all of “Pass” results are achieved by the user, the user may receive a certification from the web service that reflects the advanced planning performed by the user.

As described with various embodiments, an output of the system 100 is a business plan document 140 which can be generated in electronic or paper format. According to one or more embodiments, the business plan document 140 can be generated when the user has achieved a certain satisfactory level in the business plan. With reference to FIG. 9, for example, the business plan document 140 may be provided as an option to the user in response to the user having passed the various achievement objectives and performance review panel.

The user can view and download a complete business plan document 122 in real-time. In some variations, a document can be made available for viewing and downloading during the entire business planning sequence. Moreover, some embodiments provide that the document updates automatically in real time when the user interacts with the panels to provide new information or data. For example the user may select from the tabs in the planning sequence, change information, and have the business plan automatically updated to reflect the changed information. Specific examples of information that the user can change include, for example, type of Corporation (S versus C corp.), financial information, and business expenses and cost.

In addition to changing the business plan document 140 (FIG. 1), as mentioned with other embodiments, predictive success parameters may also be altered based on updated user information. These updates may also be updated in real-time. For example the predictive success score ‘564’ may reflect real-time input from the user.

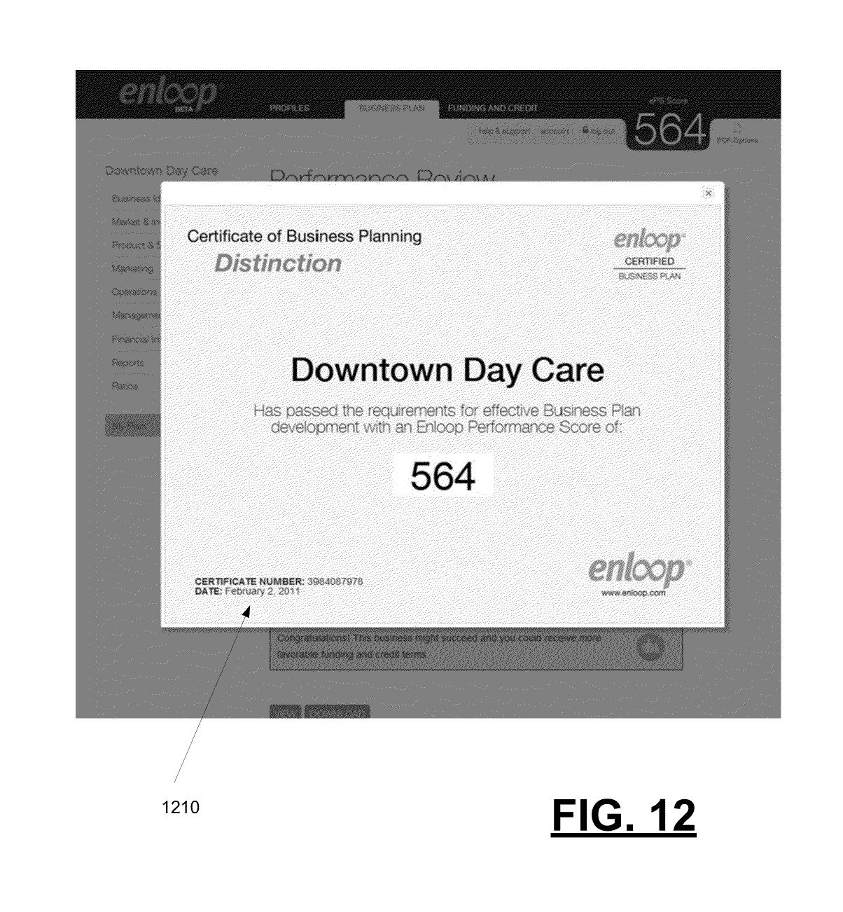

FIG. 12 illustrates a panel 1210 in which the user receives a certificate reflecting the user passing criteria set forth by the web service. The certificate may display a performance score, which corresponds to a unique identifying number and the date certificate was generated. The certificate may be generated in real-time based on a business profile's actual performance in that instance.

Dynamic Report Generation and Updating

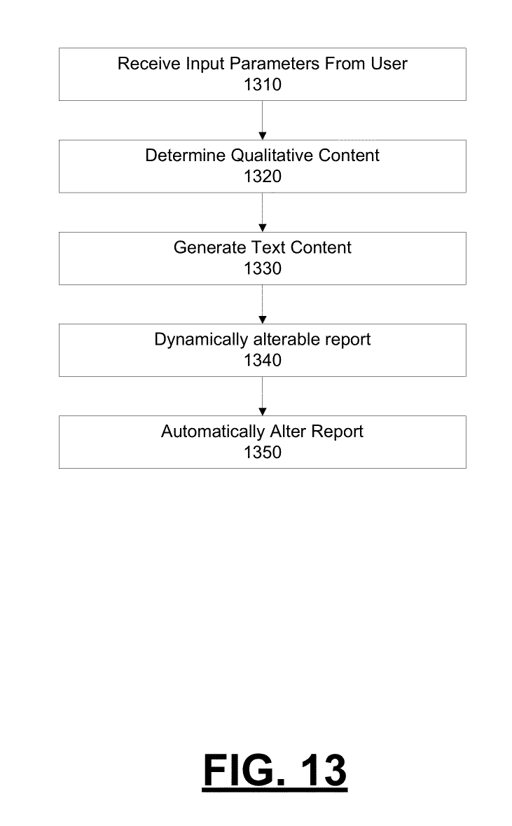

FIG. 13 illustrates a method in which a report is made dynamically configurable based on alterable input parameters provided by a user, according to one or more embodiments. In describing a method of FIG. 13, reference may be made to components described with FIG. 1 for purpose of illustrating suitable components for performing a step or sub-step being described. A method such as described by an embodiment of FIG. 13 can be used to generate different kinds of reports, such as business plans, legal documents, memorandums, etc.

In some embodiments, a report can be programmatically generated to include text content (e.g., prose, grammatically correct text content, etc.), and then altered in real-time based on (or responsively to) user input that changes some or all of the input parameters.

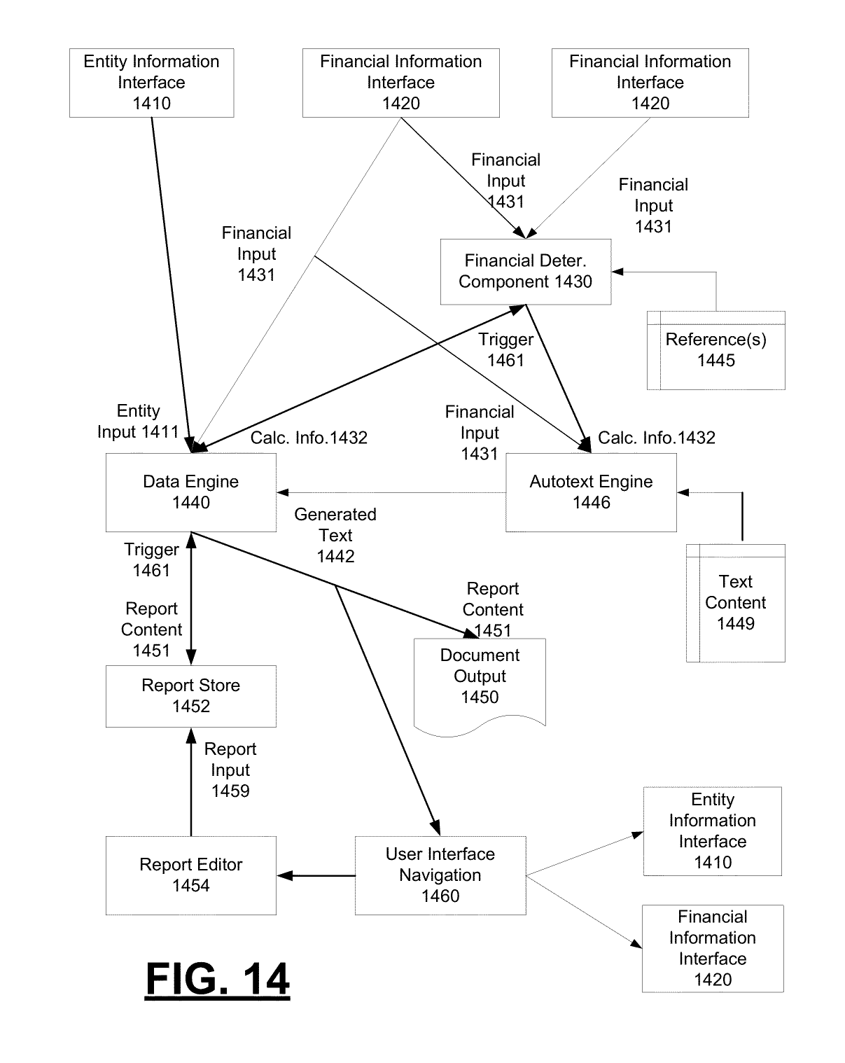

With reference to FIG. 1, for example, a report can be generated using auto text generator 134, which operates to generate sentences from report information (including parameters that are input by the user). In one implementation, the auto text generator 134 may implement, for example, a series of if/then logic statements, which substitute company information into grammatically correct sentences. In a variation such as described with FIG. 14, dynamic report generation can incorporate separate flow processes in which quantitative content (e.g., financial data) and text content are merged. As further described, some embodiments provide that separate inputs can be received and processed in order to generate quantitative content and text content as part of a report, and further that each of the quantitative and text content can be independently updated in updating the report.

In more detail, at step 1310 a set of input parameters are received from a user relating to a particular business entity. The business parameters can optionally be industry-specific, or report-type specific (e.g., business plans). In some embodiments an interface can be provided to prompt and guide a user into providing information about, for example, a particular business entity. For example, an interface may provide the user with choices using graphical features such as pull-down menus, as well as text fields for entering geographical information, and other input fields for entering accounting information.

The input parameters can be directed to processes for auto-generating text content and qualitative content. Examples of input parameters for generating text content include, company name, type of business (including sub-categories), geographical location, personnel information (including biographical information about executives and/or other employees, for example), and expected or actual financial information, including profit loss and/or revenue information. Examples of input parameters for generating qualitative content include financial data (e.g., past or historical sales, profit, projections).

In an embodiment, a method such as described with FIG. 13 can be provided as part of a web service that interacts with browsers or web-based applications of users. Accordingly, an interface may be generated as part of step 1310. The interface may correspond to, for example, a web page or set of web pages.

In step 1320, qualitative content can be determined by processes that calculate financial data and/or comparative data using the input provided by the user. For example, financial information that is provided by user input can be referenced against comparative references in order to determine business metrics that compare the financial data of the entity to industry, competitors or other sources. Likewise, other qualitative content (e.g., profitability forecasts, statistical predictions) can be calculated from input of the user using formulas or statistical determinations. The references can correspond to, for example, government publications or proprietary third-party industry information.

In one implementation, the qualitative content can be determined from business metrics using a financial determination process that references information provided by the user against independent or third-party information (e.g., industry comparisons). The metrics can be used, among other uses, to fulfill aspects of the report, such as forecasts or goals. As an example, business metrics can be used that produce a result from comparing the input parameters (e.g., business metrics) of the user to industry standard numbers. The comparison can be used as a mechanism to determine, for example, success, or to project financial information into the future.

In step 1330, text content can be generated from the user input. The text content can be determined in a process that is performed concurrently with a process for determining the qualitative content. In some embodiments, some of the text content can be conditioned or determined in part from the qualitative content. The text content can include (i) descriptive information that directly integrates the user information (e.g., business name, biography, etc.), (ii) descriptive information that is conditioned or determined from information the user provided (e.g., descriptive content relating to an industry of the business entity that provided the input, or to a geography of the business entity), and/or (iii) descriptive information that is conditioned or determined from qualitative input or business metrics. In the latter case, for example, the text content can provide context to an entity's financial performance over a given period of time, relative to industry standard. The descriptive content can also provide a template (e.g., industry-specific legal disclaimers).

In one example, the text content can be generated to merge or integrate qualitative content. For example, the text content can be generated by auto text generator 134 (see FIG. 1), which generates sentences into a cohesive report using information that is programmatically determined for the business entity. The text content can include or integrate qualitative content such as business metrics, which can be determined using a separate financial determination process.

In some embodiments, the text content can be directly or indirectly determined from the business parameters. In one embodiment, the statements of the report can reflect information or conclusions that are directly and/or indirectly determined from the business metrics (determined information) and/or inputs. Some business parameters or qualitative content can be substituted into the report (e.g., business entity name).

In providing text content, determinative logic may also be used. For example, some business parameters can be subjected to determinative logic which results in a statement reflecting the outcome of the logic, using one or more of the business parameters. For example, the input parameters can reflect actual or projected revenue. In generating portions of a business report, the logic can compare the revenue numbers to industry standards (e.g., see step 1320), consider parameters such as geography and growth, then generate statements that qualitatively express the numbers.

For example, a programmatically generated statement can resemble “We expect to generate revenue that substantially exceeds the industry norm, despite our recent profit losses.” The statement may be based on business metrics that include (i) past gross revenue, net revenue and profit/loss numbers, and (ii) geographic locality of the business entity. In generating the statement, the determinative logic may programmatically determine a forecast, and compare past and future numbers with industry standards (e.g., as determined in 1320).

The contents of the report can include information other than statements, including tables and charts. The contents of the tables and charts can also be determined from input parameters. As noted, the text content can be generated as prose, in a manner that is grammatically correct. Furthermore, the report can be generated in accordance with a set of rules that comply with an industry standard, such as GAAP.

Some embodiments provide that the report is generated using a plan builder 132 (see FIG. 1). As described above, in an embodiment the plan builder implements a report object that specifies formatting, organizational structure, and other aspects of a formal business plan. An auto text generator, as described above, may be used to generate, for example, grammatically correct prose that is in accordance with an industry business standard and which is specific to the set of input parameters provided from the user, and other sentences. In generating the report, one or more embodiments provide that the plan builder 132 presents accounting information (as provided by the user through an input interface, and/or through analysis output).

In Step 1340, the report is made dynamically alterable based on input variations provided by the user to the set of input parameters. For example, an input interface (e.g., web page) can be provided to enable a user to change at least one or more parameters in the set of input parameters. In one embodiment, the alterations to the input parameters can be in the form of the user selecting any one of multiple possible fields for the input parameters. Embodiments further provide that the generated report is shown to the user for editing, and the fields are displayed in the context of the generated report. In some embodiments, the input parameters can trigger separate processes for text and qualitative content generation. Thus, for example, a report can be updated using output from separate processes for text generation and qualitative determinations.

In step 1350 the report is automatically altered to reflect the one or more changed parameters. As described below, the alteration to the report can be based on the changes to the input parameters. In one implementation, the entire report can be re-generated anytime any portion of the report is changed. In variations, only select portions of the report (e.g., portions that actually change) are altered.

For example, in an embodiment a user may cause an input parameter corresponding to the company name to be changed. Select portions of the generated report will then be dynamically altered in response to the input parameter change. Portions of the report that may be changed include a title, a business address, or a product description. In such an embodiment the generated report may be dynamically displayed to the user and the interface may enable the user to further edit the generated report. The user may also provide input parameters for determining the qualitative content, such as the financial information or business metrics, resulting in the determination of new business metrics.

As an addition or alternative, portions of the report that are based on an outcome of determinative logic (e.g., qualitative statements regarding financial information or business metrics) can also be changed. For example, when the user enters new information, determinative logic may generate new statements which reflect new conclusions and descriptors. With reference to the specific example, “We expect to generate revenue that substantially exceeds the industry norm, despite our recent profit losses,” the alternation to the input parameters can yield a different outcome and a different statement: “We expect to generate revenue that, over time, will gradually exceed the industry norm on an annual basis, despite recent heavy losses.” As the determinative logic may rely on if/then statements and other determinations, the variations to the output statements can include variations to conclusions, projections, descriptors (e.g., adjectives), whether laudatory words can used, etc.

As an addition or alternative, the report can be altered as to entire sections that are included or not included based on the business parameters or changes thereof. For example, if the business parameters reflect a recent profit loss, or future profit loss, the report can incorporate additional sections regarding risk or reasons for loss.

As another example, a user may cause an input parameter corresponding to “inventory added” to be changed. In response, portions of the report are dynamically changed to reflect the new “inventory added” sales parameter, such as a listing of supplies expenses, a listing of maintenance expenses, or a listing of unit sales.

As another example, a user may cause a “years in business” input parameter to be changed. Sections of the report may be dynamically modified in response to the new input parameter, including a business description section, a listing of yearly sales information section, or an explanation of a derived liquidity ratio section.

The generated report may be displayed using an interface that indicates to the user which of the one or more parameters may be edited. For example, in an embodiment one or more fields may be highlighted. The highlighted fields may be selectable and editable by the user in order to change the parameter associated with the field, such as by receiving a text input from the user.

In an embodiment, an alteration to a field may cause the generated report to be altered or updated in real-time. A user may select and edit a field, which causes the corresponding input parameter to be changed. The generated report is then altered based on the input parameter.

As another example, a menu may be displayed proximately to the generated report. The menu may include a series of displayed categories for each of the one or more parameters. Embodiments provide that each of the one or more parameters belong to at least one of each of the categories, and that when a category is selected from the menu, a submenu is displayed that displays each of the one or more fields belonging to that category. For example, a first submenu labeled “Sales” could, when selected, display a listing of the set of selectable fields related to “Sales.”

Among other examples of functionality, embodiments provide that the altered report is displayed to the user in an interface enabling the user to save the generated business report. A displayable feature, such as a button, may be provided to prompt and/or enable a user to further edit the generated business report.

FIG. 14 illustrates a system for dynamically generating and updating reports for a business entity, according to one or more embodiments. A system such as shown by FIG. 14 can provide an alternative or variation to a system such as described by, for example, FIG. 1. Accordingly, a system such as described in FIG. 14 may be implemented on, for example, a server, or otherwise provided as a network service. In some implementation, a system 1400 can provide a service for users that access the system via a website (e.g., such as through a browser) or through a web-based application.

In an embodiment, system 1400 includes an entity information interface 1410, and one or more financial information interfaces 1420. The entity information interface 1410 can receive entity input 1411 from the user, such as the entity name, location, business purpose etc. The financial information interfaces 1420 can receive financial information from the user, such as prospective information and/or historical financial information.

System 1400 can implement separate processes for generating text content and data for an output. In particular, system 1400 includes a data engine 1440 and a text engine 1446. The data engine 1440 determines and maintains information that is specific to the particular entity. This can include (i) text input, such as entity input 1411, provided by the user, (ii) financial information, such as provided by financial input 1431 from the user.

In some embodiments, a financial determination component 1430 can perform computations (e.g., formulas, statistical determinations) and/or comparisons in order to generate calculated financial information 1432. The calculated financial information 1432 can be determined from the financial input 1431 of the user. For example, the financial determination component 1430 can use public or third-party references 1445 in order to determine comparative financial information (e.g., compare financial input to industry standard) or to project financial returns. The calculated financial information 1432 can be included with data that is utilized by the data engine 1440.

The text engine 1446 can provide content that is selected for the entity, but the content can also be retrieved from a text content library 1449. Some information used to select the text content can be determined from, for example, financial input 1431 or calculated financial information 1432. This inputs can enable determinative text, such as text that describes the financial health of an entity. For example, in the following statement:

“We are happy to note that profits of <DATA ENTITY> have been <DATA 30%> this quarter, outpacing the industry average by <DATA 50%>.

The phrases or sentence can be selected based in part on the financial input 1431 or calculated financial information 1432. The elements of the sentence marked by <DATA> can be inserted by the data engine 1440.

Accordingly, one or more embodiments provide for the text content engine 1446 to generate a text content output 1442 (e.g., “<DATA COMPANY NAME> had had <DATA PROFITS> profit growth this year”) for the data engine 1440. The data engine 1440 can merge or integrate data such as entity input 1411, financial input 1431 and/or calculated financial information 1432.

The output of the data engine 1440 can correspond to the report content 1451. The report content 1451 can be presented as an electronic document 1450, such as in the form of a business plan, stock or company report, or proposal. The report content can also be stored in a report data store 1452. A report editor 1454 can enable the user to alter elements of the report content 1451. In one implementation, the user can include input 1459 that modifies elements of the report content 1451. The input 1459 can trigger 1461 the data engine 1440 to update the report content 1451. The elements can correspond to, for example, financial information or entity information. The data engine 1440 can modify the entity specific data and generate updated report content 1451 responsively.

In some implementations, the financial determination component 1430 can use the trigger 1461 to perform operations (e.g., calculations, comparisons, etc.) and to generate an updated calculated financial information 1432. The updated calculated financial information 1432 can be used by the text engine 1446 to select text content 1449 and/or by the data engine 1440 to include with the report content 1451. The updated information/content can then be included in the report content 1451.

In an embodiment, system 1400 includes a user interface navigation component 1460. The user interface navigation component 1460 can operate to map elements of the report content 1451 to the specific interface from which the data element originated. When the data item is selected from the displayed output (e.g., from report document 1450), the user interface navigation component 1460 can trigger the appropriate interface to enable the user to update or modify the particular data element. For example, if the user selects text items from the report content 1451, the user interface navigation component 1460 can trigger the entity information interface 1410 to be displayed to the user, and the user is able to modify or change the text items. If the user selects financial items, the user interface navigation component 1460 triggers the financial information interface 1420 to be displayed to the user, allowing the user to modify information such as revenue or cost. When the user updates financial input 1431, the financial information component 1430 can use the input to re-calculate or update the calculated information 1432.

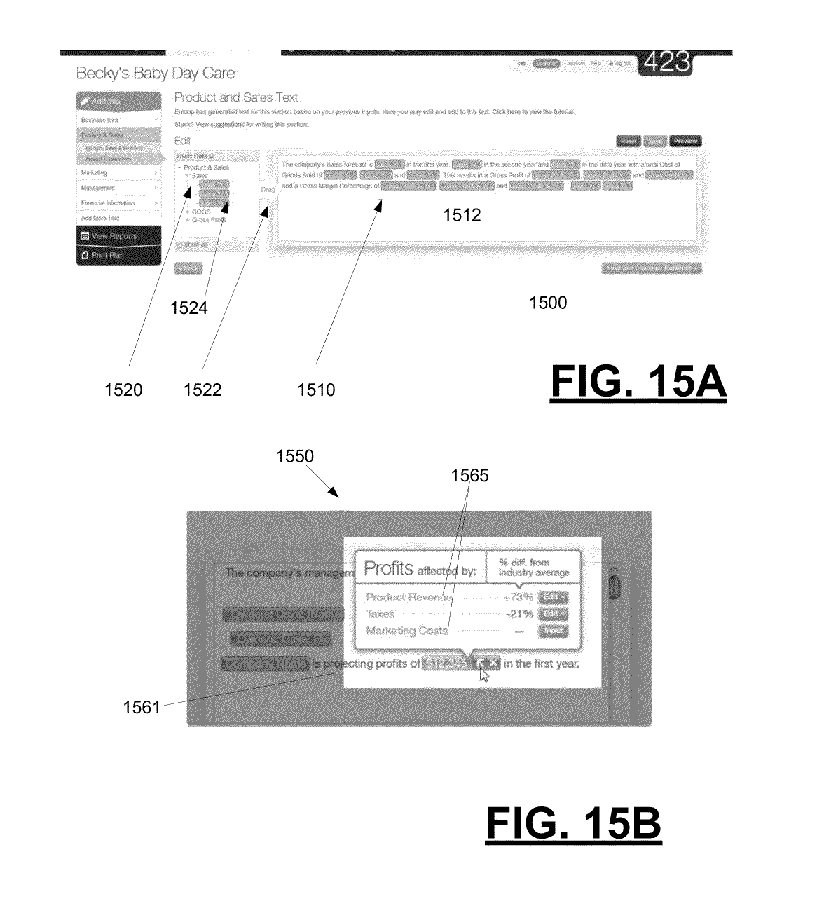

FIG. 15A illustrates an input interface which the user is enabled to change one or more parameters in the set of input parameters. Embodiments provide for the interface of FIG. 15A to enable a user to change one or more parameters in the set of input parameters as part of step 1340 of FIG. 1. The interface 1500 includes a plurality of selectable fields 1510 as part of a report 1512, each of which correspond to an input parameter of the set of input parameters. For example, the field 1510 labeled “Gross Profit Yr 1” could correspond to an input parameter “Gross Profit Year 1.” A user may select the field and then enter an input to cause the corresponding input parameter to be changed. The changed input may then be used to cause the report to be altered as illustrated by FIG. 13.

A menu 1520 may be provided proximate to the report 1512 to list the selectable fields 1510. The menu 1520 lists a set of categories and subcategories to which each of the fields 1510 belongs to. Each of the fields 1520 are displayed beneath the associated category or subcategory to which they belong to. For example, the fields “Sales Yr 1,” “Sales Yr 2,” and “Sales Yr 3” each belong to the “Sales” subcategory.

Embodiments provide for the menu 1520 to include one or more menu fields 1524, each of the menu fields 1524 corresponding to a field 1512 and an input parameter. In an embodiment a user may select a menu field 1524 and enter an input to cause the corresponding field 1512 and corresponding input parameter to be changed. In such an embodiment the report 1512 is then changed to reflect the changed input parameter.

Embodiments provide that a field displayed in the menu may be caused to be moved from the menu to the report 1512. A prompt 1522 may be displayed proximate to the menu to indicate such functionality to the user.

In an embodiment, an alteration to a field 1510 may cause the generated report 1512 (or portion thereof) to be altered or updated in real-time. A user may select and edit a field 1510, which causes the corresponding input parameter to be changed. The generated report 1512 is then altered in real-time based on the input parameter. Similarly, embodiments provide that a user may select and edit menu field 1524 to cause a corresponding input parameter to be changed, and the generated report 1512 to be altered based on the changed input parameter, in real time.

FIG. 15B illustrates an example interface to enable element selection and inspection, under an embodiment. An example interface 1550 can be generated by, for example, the user interface navigation component 1460 (see FIG. 14). With reference to FIG. 14 and FIG. 15B. the user interface navigation component 1460 can map data elements of, for example, report content 1451 to identify interfaces and computations that resulted in the financial amount. In the example provided by FIG. 15B, report content 1561 can include financial elements 1565 which map to financial input 1431 provided by the user and/or financial determination component 1430. The user interface navigation component 1460 incorporate or access functionality that itemizes the data elements into sub-components (e.g., as provided by the user), and further triggers computations which can proportion the data element to relevant parts and/or perform comparative analysis on the relevant parts of the computation. As shown by the example of FIG. 15B, the user can utilize the interface 1550 to quickly understand why an output figure has a certain value, understand what individual data variables contribute to the output, and/or quickly access the relevant component variables and comparisons (e.g., using references).

Computer Hardware

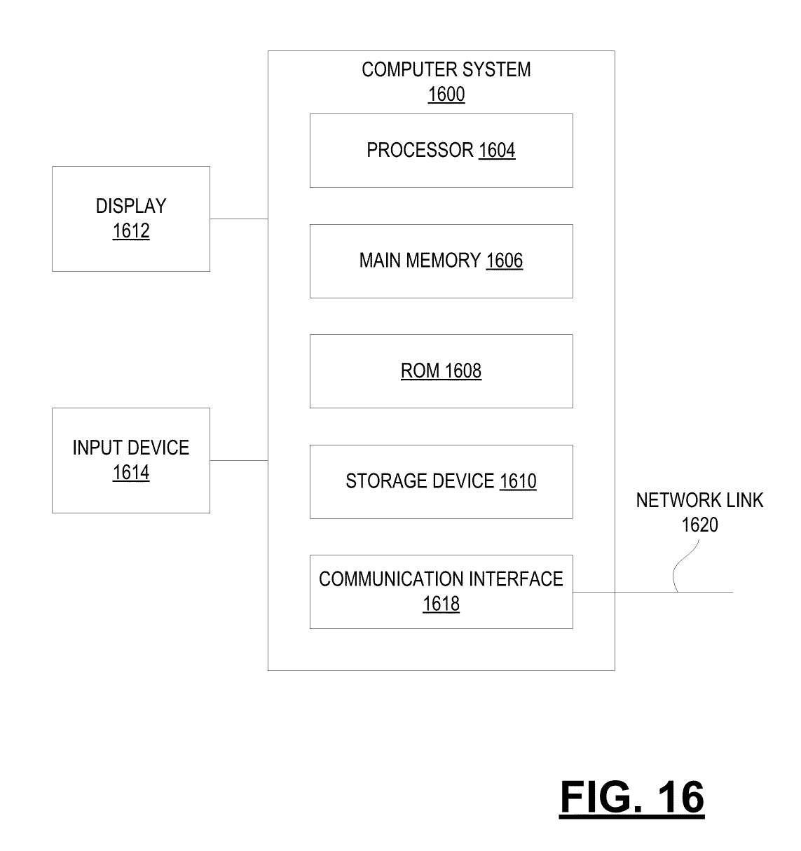

In an embodiment, one or more components of the system 100 (FIG. 1) may be implemented on or using a computer system. FIG. 16 is a block diagram that illustrates a computer system 1600 upon which one or more embodiments may be implemented. In an embodiment, computer system 1600 includes processor 1604, main memory 1606, ROM 1608, storage device 1610, and communication interface 1618. Computer system 1600 includes at least one processor 1604 for processing information. Computer system 1600 also includes a main memory 1606, such as a random access memory (RAM) or other dynamic storage device, for storing information and instructions to be executed by processor 1604. Main memory 1606 also may be used for storing temporary variables or other intermediate information during execution of instructions to be executed by processor 1604. Computer system 1600 further includes a read only memory (ROM) 1608 or other static storage device for storing static information and instructions for processor 1604. A storage device 1610, such as a magnetic disk or optical disk, is provided for storing information and instructions.

Computer system 1600 may be coupled to a display 1612, such as a cathode ray tube (CRT), a LCD monitor, or a television set, for displaying information to a user. An input device 1614, including alphanumeric and other keys, is coupled to computer system 1600 for communicating information and command selections to processor 1604. Other non-limiting, illustrative examples of input device 1614 include a mouse, a trackball, or cursor direction keys for communicating direction information and command selections to processor 1604 and for controlling cursor movement on display 1612. While only one input device 1614 is depicted in FIG. 16, embodiments disclosed herein may include any number of input devices 1614 coupled to computer system 1600.

One or more embodiments are related to the use of computer system 1500 for implementing the techniques described herein. According to one embodiment, those techniques are performed by computer system 1500 in response to processor 1504 executing one or more sequences of one or more instructions contained in main memory 1506. Such instructions may be read into main memory 1506 from another machine-readable medium, such as storage device 1510. Execution of the sequences of instructions contained in main memory 1506 causes processor 1504 to perform the process steps described herein. In alternative embodiments, hard-wired circuitry may be used in place of or in combination with software instructions to implement embodiments of the invention. Thus, embodiments disclosed herein are not limited to any specific combination of hardware circuitry and software.

The term “machine-readable storage medium” as used herein refers to any medium that participates in storing instructions which may be provided to processor 1504 for execution. Such a medium may take many forms, including but not limited to, non-volatile media and volatile media. Non-volatile media includes, for example, optical or magnetic disks, such as storage device 1510. Volatile media includes dynamic memory, such as main memory 1506.

Non-limiting, illustrative examples of machine-readable media include, for example, a floppy disk, a flexible disk, hard disk, magnetic tape, or any other magnetic medium, a CD-ROM, any other optical medium, a RAM, a PROM, and EPROM, a FLASH-EPROM, any other memory chip or cartridge, or any other medium from which a computer can read.

Various forms of machine readable media may be involved in carrying one or more sequences of one or more instructions to processor 1504 for execution. For example, the instructions may initially be carried on a magnetic disk of a remote computer. The remote computer can load the instructions into its dynamic memory and send the instructions over a network link 1520 to computer system 1500.

Communication interface 1518 provides a two-way data communication coupling to a network link 1520 that is connected to a local network. For example, communication interface 1518 may be an integrated services digital network (ISDN) card or a modem to provide a data communication connection to a corresponding type of telephone line. As another example, communication interface 1518 may be a local area network (LAN) card to provide a data communication connection to a compatible LAN. Wireless links may also be implemented. In any such implementation, communication interface 1518 sends and receives electrical, electromagnetic or optical signals that carry digital data streams representing various types of information.

Network link 1520 typically provides data communication through one or more networks to other data devices. For example, network link 1520 may provide a connection through a local network to a host computer or to data equipment operated by an Internet Service Provider (ISP).

Computer system 1500 can send messages and receive data, including program code, through the network(s), network link 1520 and communication interface 1518. For example, a server might transmit a requested code for an application program through the Internet, a local ISP, a local network, subsequently to communication interface 1518. The received code may be executed by processor 1504 as it is received, and/or stored in storage device 1510, or other non-volatile storage for later execution.

In various embodiments, system 1500 is implemented on a server for devices such as personal computers, portable computers, and mobile devices. The system 1500 may be operated as a shared platform, such as one that includes a web application operating on a device (and which communicates with a corresponding server application). In one implementation, the system 100 may be implemented in whole or in part by use of a mobile web application.

Although illustrative embodiments have been described in detail herein with reference to the accompanying drawings, variations to specific embodiments and details are encompassed by this disclosure. It is intended that the scope of the invention is defined by the following claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A computer-implemented method for generating a user-specific document, the method being implemented by one or more processors and comprising:
receiving a set of input parameters from the user relating to a particular business entity;
programmatically generating a report for the user that includes text content, the text content including grammatically correct statements that are based on the set of input parameters provided from the user;
enabling the user to change at least one of one or more parameters in the set of input parameters; and
automatically altering a portion of the report to reflect the at least one of the one or more parameters being changed.

2. The method of claim 1, wherein enabling the user to change the one or more parameters includes providing an interface that is operable to display at least some of the set of input parameters while concurrently generating at least a portion of the report.

3. The method of claim 2, wherein altering the report includes providing the report concurrently with the set of input parameters after the one or more parameters are changed.

4. The method of claim 1, wherein enabling the user to change the one or more parameters comprises providing the user with an interface to receive a text input corresponding to one of the one or more the alterable text fields, and wherein automatically altering the report comprises altering the one of the one or more alterable text fields to reflect the text input.

5. The method of claim 1, further comprising displaying a sidebar showing one or more expandable categories, each of the expandable categories corresponding to at least one alterable text field.

6. The method of claim 1, wherein the report is generated in accordance with Generally Accepted Accounting Principles (GAAP).

7. The method of claim 1, wherein programmatically generating the report includes determining an outcome from one or more of the input parameters, and then generating one or more statements that are descriptive of the outcome.

8. A computer system comprising:
a memory that stores a set of instructions;
one or more processors that use instructions stored in memory to provide:
an interface, including one or more fields to enable a user to submit one or more input parameters;
logic that generates a report, including a set of grammatically correct statements as part of the report, the report being generated in accordance with one or more standards and incorporating information provided by the one or more of the input parameters;
wherein the interface is operable to receive input to alter one or more of input parameters after the report is generated; and
wherein the logic is responsive to the one or more input parameters being altered to update the report to incorporate information provided by the altered one or more input parameters.

9. The system of claim 8, wherein the processor includes instructions to receive input to alter one or more of input parameters while concurrently generating at least a portion of the report.

10. The system of claim 9, wherein the processor includes instructions to generate the report concurrently with the set of input parameters after the one or more parameters are changed.

11. The system of claim 8, wherein the interface is operable to receive a text input corresponding to one of the one or more alterable text fields, and wherein the processor includes instructions to alter one of the one or more alterable text fields to reflect the text input.

12. The system of claim 8, wherein the processor further comprises instructions to display a sidebar showing one or more expandable categories, each of the expandable categories corresponding to at least one alterable text field.

13. The system of claim 8, wherein the logic includes determinative logic that determines an outcome based on the one or more input parameters, and wherein generates one or more statements for the report that describe or incorporate the outcome.

14. A non-transitory computer-implemented readable medium carrying instructions for generating a user-specific document, the instructions being executable by one or more processors to perform operations comprising:
receiving a set of input parameters from the user relating to a particular business entity;
programmatically generating a report for the user that includes text content, the text content including grammatically correct statements that are based on the set of input parameters provided from the user;
enabling the user to change at least one of one or more parameters in the set of input parameters; and
automatically altering a portion of the report to reflect the at least one of the one or more parameters being changed.

15. A computer system comprising:
a memory that stores a set of instructions;
one or more processors that use the instructions stored in the memory to provide:
one or more user interfaces to receive user input that includes entity information and financial information;
a first process that uses at least one of the entity information or financial information to select text content; and
a second process that uses the financial information to perform calculations and generate calculated financial information; and
a third process that merges the entity information, the financial information and calculated financial information with the text content.

16. The system of claim 15, wherein the text content is not specific to the entity.

17. The system of claim 15, further comprising instructions that cause the second process to perform a comparison against industry standards to determine comparative financial information.

18. The system of claim 17, further comprising instructions that cause the second process to perform the comparison against industry standards includes using GAAP standards.

19. The system of claim 15, further comprising instructions that cause the third process to display a grammatically correct report including the merged entity information, financial information and calculated financial information to a user.

20. The system of claim 19, further comprising instructions that cause the third process to display one or more user-editable fields in the grammatically correct report.
